(19) United States
(12) Patent Application Publication
(10) Pub. No.: US 2009/0167839 A1
(43) Pub. Date: Jul. 2, 2009

(54) METHODS AND APPARATUS FOR PROVIDING COMMUNICATION BETWEEN MULTIPLE TELEVISION VIEWERS

(76) Inventor: Desmond Ottmar, Englewood, CO (US)

Correspondence Address: EchoStar Technologies, L.L.C.;Legal Department, 9601 SOUTH MERIDIAN BOULEVARD, ENGLEWOOD, CO, 80112, US

(21) Appl. No.: 11/964,927

(22) Filed: Dec. 27, 2007

(51) Int. Cl. H04N 7/14; H04N 7/173

(52) U.S. Cl. 348/14.08; 725/106; 348/E07.077

(57) ABSTRACT

Various embodiments of apparatus and/or methods are described for providing communication between multiple television viewers. A television receiver receives broadcast television content and outputs the broadcast television content for presentation on a presentation device. A link is established between the local television receiver and a remote television receiver. The local television receiver receives non-broadcast content from the remote television receiver, and outputs the non-broadcast content simultaneously with the broadcast television content for presentation on the presentation device.

### BACKGROUND

People often like to watch television programs and movies with friends and family. A group of people may gather around a television to experience their favorite television show, movie or sporting event together. Watching television is a social experience, and people often discuss topics related to the television programming. For example, when watching sports, people often like to discuss the team or the players participating in the game. However, when people are remotely located with respect to each other, it becomes difficult to maintain the social experience of watching television together.

Many people try to maintain the social experience of watching television together while they are apart by communicating over a distinct communication medium, such as a telephone. Seinfeld fans will remember when Kramer's girlfriend moves across the city, and Kramer attempts to watch a television movie while talking on the phone with his girlfriend. However, this solution has several inadequacies. It is awkward to hold a telephone while watching programming having a lengthy duration, such as movies and sporting events. Additionally, a viewer's telephone is tied up during the conversation, and they may be unable to accept phone calls from other people during the duration of the conversation. Also, one person is not able to see the physical reactions of the other participant in the conversation, which makes it difficult to fully experience the social interaction.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of a content distribution system.

FIG. 3 illustrates an embodiment of functional components of the local set-top box of FIG. 2.

FIG. 4 illustrates an embodiment of a satellite broadcast system.

FIG. 5 illustrates an embodiment of a cable television distribution system.

FIG. 6 illustrates an embodiment of a process for providing communication between multiple television viewers.

FIG. 7 illustrates an embodiment of a process for presenting video chat data in trick play mode.

FIG. 8 illustrates an embodiment of a process for providing chat data to a third party recipient.

### DETAILED DESCRIPTION

The various embodiments described herein generally provide apparatus, systems and methods which facilitate the reception, processing, and outputting of presentation content. More particularly, the apparatus, systems and methods described herein facilitate the transmission of audio and video chat data that may be presented on a presentation device in association with other presentation content. In short, various embodiments described herein provide apparatus, system and/or methods for providing communication between multiple viewers of presentation content at disparate locations.

In at least one embodiment, the presentation content to be received, processed, outputted and/or communicated may come in any form of a video stream. It is to be appreciated that the video stream may be supplied by any source, such as an over-the-air broadcast, a satellite or cable television distribution system, a digital video disk (DVD) or other optical disk, the internet or other communication networks and the like. In at least one embodiment, the video stream may comprise both video data and audio data.

In various embodiments described herein, the chat data of a first user is captured at a first presentation device and transmitted to a second presentation device for presentation to a second user. The chat data may be captured in any format, including video data, audio data, image data, text data or any combination thereof. The chat data is then presented in association with the presentation content (e.g., broadcast video content) by the second presentation device.

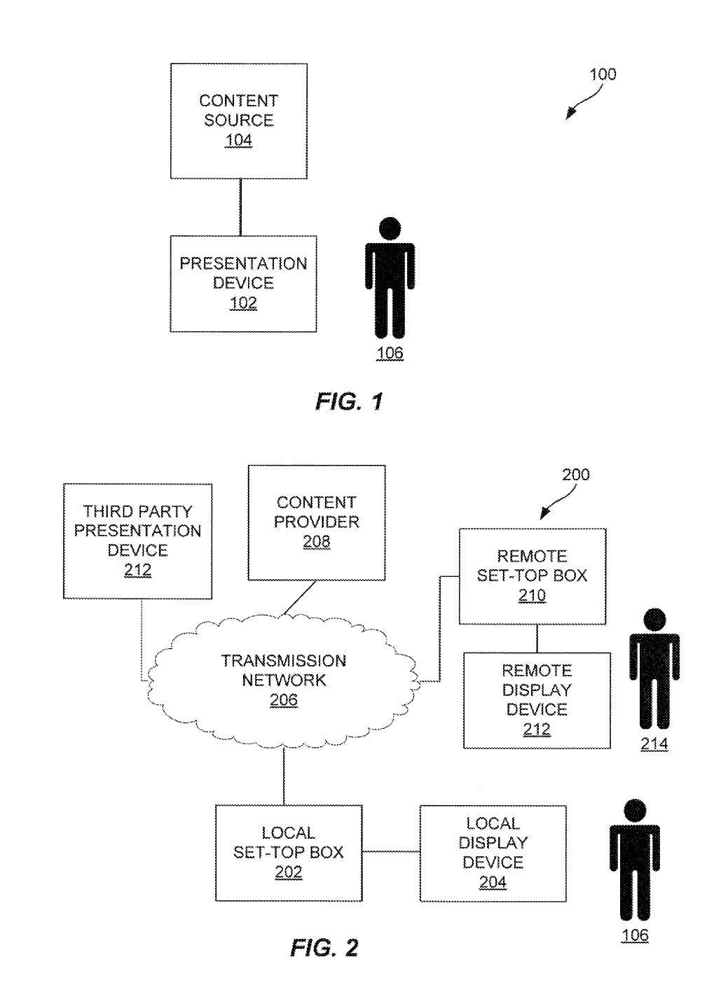

FIG. 1 illustrates an embodiment of an entertainment system 100. The entertainment system 100 presents content to a user 106. In at least one embodiment, the content presented to the user 106 includes a video stream, such as a television program, movie or other recorded content and the like. The entertainment system 100 includes a presentation device 102 and a content source 104. Each of these components is discussed in greater detail below.

The presentation device 102 is configured to receive content from one or more content source(s) 104, and to present the received content to the user 106. In at least one embodiment, the presentation device 102 is a display device configured to display content to the user 106. The presentation device 102 may receive a video stream in any format (e.g., analog or digital format), and present the video stream to the user 106. In at least one embodiment, the presentation device 102 receives video content from the content source 104, and presents the video content in a display area of the presentation device 102. The presentation device 102 further receives chat data, and presents the chat data from the content source 104 in association with the video content. The chat data may come in any format, including audio data, video data, image data, text data or any combination thereof.

In at least one embodiment, the chat data includes audio data, and the presentation device 102 simultaneously presents the audio data with the video content received from the content source 104. If the video content includes an audio component, then the audio component and the audio chat data may be mixed together and presented through an audio output of the presentation device 102. In at least one embodiment, the audio component of the video content is muted during presentation of the audio chat data.

In at least one embodiment, the chat data includes video data, and the presentation device 102 simultaneously presents the video chat data with the video content received from the content source 104. For example, the video chat data and the video content may be presented in a picture-in-picture (PIP) or split screen mode. Thus, the video chat data may be presented in a first region of the display area of the presentation device 102, and the video content may be presented in a second region of the display area. In at least one embodiment the video chat data and the video content both include associated audio components that are mixed together and simultaneously presented through an audio output of the presentation device 102. It is to be appreciated that the user 106 may video chat with multiple remote users simultaneously. Thus, the presentation device 102 may present multiple PIP windows, each PIP window displaying video chat data for one remote user.

The content source 104 may comprise any system or apparatus configured to provide presentation data, such as a video stream, to the presentation device 102. The content source 104 may be external or internal to the presentation device 102. The presentation device 102 and the content source 104 may be communicatively coupled through any type of wired or wireless connection, communication network and the like. Exemplary content sources include television distribution systems (e.g., over the air distribution systems, cable television distribution systems, satellite television distribution systems and broadband distribution systems), set-top boxes, DVD players and other optical disk players, digital storage mediums (e.g., DVRs) and the internet.

In at least one embodiment, the content source 104 further provides chat data to the presentation device 102. The originating source of the chat data may be different than the originating source of the video content. Further, the chat data and the video content may be received by the content source 104 and/or the presentation device through different communication paths. For example, the video content may be provided to the content source 104 by a satellite television provider, whereas, the chat data may be provided to the content source 104 by a remote television receiver (e.g., a remote set-top box) over an internet connection or other type of data network.

The presentation device 102 may receive the video content and the chat data in a single signal or through multiple signals. Further, the presentation device 102 may receive the video content and the chat data through a single input or multiple inputs. For example, the content source 104 may comprise a set-top box that receives broadcast video content (e.g., a television program) and video chat data and combines both signals to output a single video signal provided to the presentation device 102. In some embodiments, the presentation device 102 may receive the video chat data and the video content through multiple inputs (e.g., on two different channels), and may present the video chat data and the video content in a PIP mode. Thus, through the operation of the entertainment system 100, the user 106 is presented with chat data and other presentation content (e.g., broadcast video content) simultaneously. Entertainment system 100 may include other elements or components not illustrated for the sake of brevity.

FIG. 2 illustrates an embodiment of a content distribution system 200. The content distribution system 200 is configured to present presentation content and chat data to a user 106. More particularly, the content distribution system 200 facilitates a conversation between two remotely located users 106 and 214 through the users' television receivers. The content distribution system 200 includes a local set-top box 202, a local display device 204, a transmission network 206, a content provider 208, a remote set-top box 210 and a display device 212. Each of these components is discussed in greater detail below.

The display device 204 may comprise any type of device operable for receiving and displaying analog and/or digital video signals. In at least one embodiment, the display device 204 may be a television set or video display that contains an integrated television converter device (e.g., an internal cable-ready television tuner housed inside a television), or, alternatively, that is connected to an external television converter device for receiving and demodulating analog and/or digital signals for presentation on the local display device 204 (e.g., the local set-top box 202).

Using an integrated television converter device, the local display device 204 may be operable to communicate directly with the transmission network 206. For example, the transmission network 206 may comprise an over-the-air distribution system (e.g., free television), and the local display device 204 may receive television broadcast signals using an internal or external antenna. The transmission network 206 may also comprise a cable television distribution system, and the local display device 204 may comprise a cable ready television adapted to receive and demodulate analog or digital cable television signals for presentation to the local user 106. A direct broadcast satellite or other type of wired or wireless communications network may also be used solely or in conjunction with the foregoing. In at least one embodiment, the local display device 204 may communicate with the transmission network 206 through an intermediate television receiver device, such as the local set-top box 202 that receives and demodulates analog and/or digital signals for presentation on the display device 204 that the display device 204 itself is unable to receive.

The local set-top box 202 is communicatively coupled to the local display device 204 through any type of wired or wireless connection. Exemplary wired connections include coax, fiber, composite video and high-definition multimedia interface (HDMI). Exemplary wireless connections include WiFi and Bluetooth. In at least one embodiment, the local set-top box 202 is embodied in a television converter device (e.g., a satellite television receiver). The local set-top box 202 may also be incorporated into the local display device 204.

As illustrated in FIG. 2, the local set-top box 202 is coupled to a content provider 208 (e.g., a satellite television provider) through the transmission network 206. Thus, the local set-top box 202 receives a television signal (e.g., a broadcast) or other data signal (e.g., digital video data or other data formatted into a video stream) from the transmission network 206, and outputs television programs and other content provided by the content provider 208 to the local display device 204. In at least one embodiment, the local set-top box 202 includes digital video recorder (DVR) functionality that captures and records video content onto a storage medium for subsequent presentation to the local user 106. It is to be appreciated that the local set-top box 202 may capture and record video streams from non-broadcast devices, such as video recorders, DVD players, personal computers, the internet or other storage devices (e.g., universal serial bus (USB) flash drives).

The local set-top box 202 may include a remote control or other input device (not shown) that the local user 106 may utilize for remotely operating the set-top box 202 and/or the local display device 204. More specifically, a remote control may be operable for controlling the presentation of video and/or other data presented by the local set-top box 202 on the local display device 204. In at least one embodiment, the remote control includes a microphone for capturing audio chat data from the local user 106. In some embodiments, the local set-top box 202 may include a video camera that is internal to the local set-top box 202 or communicatively coupled to the local set-top box 202 to capture video and/or audio chat data from the local user 106.

The chat data is transmitted by the local set-top box 202 to a remote set-top box 210 located remotely with respect to the local set-top box 202. For example, the local set-top box 202 maybe located in a different building, city or even country than the remote set-top box 210. However, it is to be appreciated that the relative locations of the local set-top box 202 and the remote set-top box 210 may be significantly closer. For example, the local set-top box 202 and the remote set-top box 210 may be located in different rooms of the same building.

The remote set-top box 210 may be similar in configuration and functionality to the local set-top box 202, and is communicatively coupled to a remote display device 212. The remote set-top box 210 is communicatively coupled to the local set-top box 202 through the transmission network 206. In at least one embodiment, the local set-top box 202 and the remote set-top box 210 communicate over the same communication path as each receives a broadcast television signal. For example, the local set-top box 202 and the remote set-top box 210 may receive both broadcast video content and chat data over a broadband connection. In other embodiments, the transmission network 206 may include multiple communication, paths for providing video content and chat data to the local set-top box 202 and the remote set-top box 210. For example, the local set-top box 202 and the remote set-top box 210 may receive video content from the content provider 208 over a satellite television distribution network, and may communicate with each other through a broadband connection. In some embodiments, the local set-top box 202 and the remote set-top box 210 may receive video content over disparate communication paths. For example, the local set-top box 202 may receive video content over a satellite television distribution network, and the remote set-top box 210 may receive video content over a cable television distribution network.

The remote set-top box 210 receives chat data from the local set-top box 202, and outputs the chat data for presentation to the remote user 214, on the remote display device 212, in association with the presentation content received from the content provider 208. For example, the chat data may include video data that is presented by the remote display device 212 simultaneously with video content of a football game in a PIP mode. Likewise, the remote set-top box 210 captures chat data of the remote user 214, and transmits the chat data to the local set-top box 202 for presentation to the local user 106.

In at least one embodiment, the local set-top box 202 records the chat data received from the remote-set top box 210 for subsequent presentation to the local user 106. For example, while watching the football game with a PIP video chat display, the local user 106 may perform trick play operations on the video chat data (e.g., rewind, fast forward or pause the video chat data). In some embodiments, the local user 106 may desire to subsequently experience the chat data at a later time without experiencing the original video content that corresponds with the chat data. For example, the local user 106 may desire to see their friend's reaction to a touchdown in the football game several days later.

In some embodiments, the local set-top box 202 records audio or video data of the local user 106 for subsequent presentation to the local user 106. In other words, as the local set-top box 202 captures and transmits audio and/or video chat data of the local user 106 to the remote set-top box 210, the local set-top box 202 may record the audio and/or video chat data for later viewing. In at least one embodiment, the remote set-top box 210 may provide the local set-top box 202 with both chat data and video content. In other words, the local set-top box 202 receives video content from the remote set-top box 210. For example, the remote set-top box 210 may store a recorded video, and may provide the recorded video to the local set-top box 202 over a broadband connection. Thus, users 106 and 214 may be presented with essentially the same content emanating from the same content source. In at least one embodiment, the remote set-top box 210 provides the chat data and the video content to the local set-top box 202 in a combined composite signal. In other words, the remote set-top box 210 formats the chat data and the video content in a PIP or split screen video output, and transmits the video output to the local set-top box 202 for presentation by the local display device 204.

In at least one embodiment, the local set-top box 202 may be configured to transmit portions of the audio and/or video chat data to third party recipients through a third party presentation device 212. For example, the local user 106 may select a portion of the chat data featuring the remote user 214 and transmit the selected portion to the third party presentation device 212. Likewise, if the local set-top box 202 captures audio and/or video chat data of the local user 106, then the local user 106 may select portions of the chat data for transmission to a third party recipient. The third party presentation device 212 comprises any type of device capable of receiving and presenting content to a user, such as another set-top box, television, computer, personal digital assistant (PDA), mobile or wireless telephone and the like.

The content provider 208 comprises any source or sources of television or other video signals. In at least one embodiment, the content provider 208 provides a television broadcast signal to the set-top box 202 over the transmission network 206. The content provider 208 maybe a television station that generates and provides the content or may be a television service that provides retransmission of television signals (e.g., a satellite television provider). It is to be appreciated that the content provider 208 may also provide some retransmission services while generating and providing some original or derivative content.

The transmission network 206 may comprise any type of communication network utilized between the set-top box 202 and the content provider 208. Exemplary communication networks include television distribution networks (e.g., over the air, satellite and cable television networks), wireless communication networks, public switched telephone networks (PSTN), and local area networks (LAN) or wide area networks (WAN) providing data communication services. The transmission network 206 may utilize any desired combination of wired (e.g., cable and fiber) and/or wireless (e.g., cellular, satellite, microwave, and radio frequency) communication mediums and any desired network topology (or topologies when multiple mediums are utilized). The local set-top box 202 and/or the remote set-top box 210 may communicate with the transmission network 206 through a wired or wireless connection. The transmission network 206 may distribute television broadcast and other data signals in digital or analog form. Exemplary video formats include moving pictures expert group (MPEG), flash, Windows Media, and the like. Content distribution system 200 may include other elements or components not illustrated for the sake of brevity.

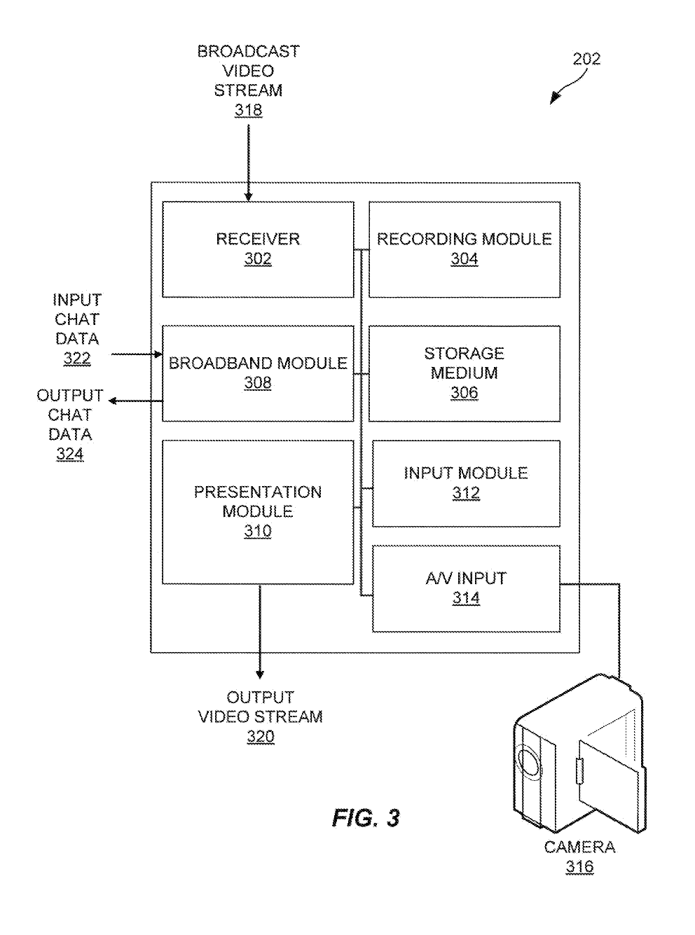

FIG. 3 illustrates an embodiment of functional components of the local set-top box 202 of FIG. 2. FIG. 3 will be discussed in reference to the content distribution system 200 illustrated in FIG. 2. The local set-top box 202 comprises a receiver 302, a recording module 304, a storage medium 306, a broadband module 308, a presentation module 310, an input module 312, an audio/video (A/V) input 314 and a camera 316. Each of these components is discussed in greater detail below.

The receiver 302 receives a broadcast video stream 318 from the transmission network 206 (see FIG. 2). The receiver 302 may comprise a wired or wireless receiver. In at least one embodiment, the receiver 302 receives the broadcast video content from a satellite television distribution system. If necessary, the receiver 302 may perform demodulation and/or filtering of the broadcast video stream 318 signal to generate a format utilized by the presentation module 310. The receiver 302 may further receive other data (e.g., chat data) from the transmission network 206. In at least one embodiment, the receiver 302 may also include transmitter functionality to transmit data across the transmission network to the content provider 208 (see FIG. 2) or the remote set-top box 210. For example, the local set-top box 202 may transmit chat data to the remote set-top box 210 through the satellite television distribution network.

The broadband module 308 is connected to a broadband data network and provides bi-directional data transmission between the local set-top box 202 and the remote set-top box 210. Thus, the broadband module 308 receives input chat data 322 from the remote set-top box 210 and transmits output chat data 324 to the remote set-top 210. In at least one embodiment, the broadband module 308 is an Ethernet connection communicatively coupled to the internet or other type of data communication network. It is to be appreciated that other types of wired and wireless broadband connections may be utilized.

The presentation module 310 is configured to receive the broadcast video stream and the input chat data 322 and output an output video stream 320 for presentation on the display device 204 (see FIG. 2). In at least one embodiment, the output video stream 320 comprises a PIP or split screen video signal generated based on the broadcast video stream 318 and the input chat data 322. The presentation module 310 may also retrieve recorded content stored on the storage medium 306 to output the output video stream 320. For example, the presentation module 310 may generate an output video stream 320 based on recorded television shows and/or recorded chat data stored on the storage medium. The presentation module 310 may also generate and output other video data, such as menus and user interfaces, for presentation on the display device 204 (see FIG. 2). In at least one embodiment, the A/V input 314 is a Bluetooth receiver/transmitter configured to wirelessly communicate with Bluetooth enabled devices, such as microphones, cameras and mobile telephones. Thus, the A/V input 314 may capture audio data, video data, text data and/or image data from a Bluetooth enabled device.

The input module 312 is configured to receive user input data from the local user 106. In at least one embodiment, the input module 312 communicates with external input devices, such as remote controls, keyboards, mice, mobile telephones and the like. In at least one embodiment, the input module 312 is an infrared (IR) or radio frequency (RF) transmitter/receiver configured to wirelessly communicate with a television remote control (not shown). The remote control may be configured to remotely control output of the output video stream 320 by the local set-top box 202. In at least one embodiment, a remote control may be configured to remotely control the capture of chat data by the camera 316. In at least one embodiment, the input module 312 is a keypad, touch screen or other input device mounted on a casing of the local set-top box 202.

The A/V input 314 is communicatively coupled to a camera 316 that captures video data of the local user 106 (see FIG. 2). In at least one embodiment, the camera 316 includes a microphone for capturing audio data associated with the video data of the local user 106. In some embodiments, the A/V input 314 may be communicatively coupled to a microphone (not shown) rather than the camera 316, and the microphone may capture audio data of the local user 106. The camera 316 may be internal or external to the local set-top box 202. For example, the camera 316 may be mounted to an external casing of the local set-top box 202. The camera 316 may also communicatively couple to the A/V input 314 through a wired or wireless connection, such as a universal serial bus (USB) cable or a Bluetooth connection. Responsive to the A/V input 314 capturing chat data from the local user 106, the broadband module 308 transmits output chat data 322 over the transmission network 206 to the remote set-top box 210.

The recording module 304 is configured to record video streams and other A/V data to the storage medium for subsequent presentation. In at least one embodiment, the recording module 304 receives the broadcast video stream 318 and stores the broadcast video stream 318 to the storage medium. In some embodiments, the recording module 304 receives the input chat data 322 and stores the input chat data 322 to the storage medium for subsequent presentation. In at least one embodiment, the remote user 106 may experience the input chat data 322 at a later time or may perform trick mode functions (e.g., rewind) during viewing of the broadcast video stream 318. The storage medium 306 maybe any type of temporary or persistent storage device capable of storing the broadcast video stream 318 and the input chat data 322. The storage medium 306 may be internal and/or external to the local set-top box 202. For example, the storage medium 306 may be an internal hard drive or flash memory. The broadcast video stream 318 and the input chat data 322 may be stored together and/or separately on the storage medium 306.

Those of ordinary skill in the art will appreciate that the various functional elements 302 through 316 show as operable within the local set-top box 202 may be combined into fewer discrete elements or may be broken up into a larger number of discrete functional elements as a matter of design choice. For example, the parsing broadband module 308, the recording module 304, the input module 312, the A/V input 314 and/or the presentation module 310 may be combined into one or more processors or processing modules. Thus, the particular functional decomposition suggested by FIG. 3 is intended merely as exemplary of one possible functional decomposition of elements within the local set-top box 202.

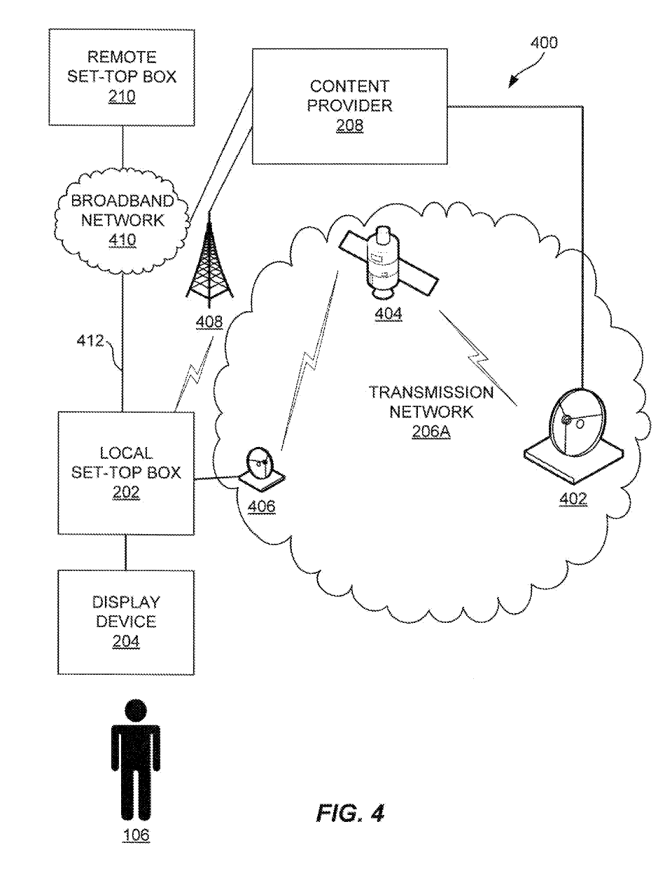

FIG. 4 illustrates an embodiment of a satellite broadcast system 400. More particularly, FIG. 4 illustrates details of a transmission network 206A. Satellite broadcast system 400 will be discussed in reference to content distribution system 200 illustrated FIGS. 2-3.

Satellite broadcast system 400 includes a content provider 208 in signal communication with an uplink system 402 of a transmission network 206A. The content provider 208 provides the uplink system 402 with television programs that are transmitted to a set-top box 202. Television programs may be broadcast by the transmission network 206A to the set-top box 202. The television program may be embodied as MPEG-2, MPEG-4 or other digital video signals, analog or baseband signals, and/or other video data of a channel of the satellite broadcast system 400.

Satellite broadcast system 400 further comprises a satellite 404 in signal communication with the uplink system 402. The satellite 404 broadcasts television programs received from the uplink system 402. The satellite broadcast system 400 further comprises a satellite antenna 406 for receiving the television program broadcast from the satellite 404. The satellite antenna 406 is in signal communication with the local set-top box 202, and provides the local set-top box 202 with the television program. The broadcast television program content is received by the local set-top box 202, and outputted for presentation on the display device 204. In at least one embodiment, the transmission network 206A may also be configured to transmit video chat data between the local set-top box 202 and the remote set-top box 210 (see FIG. 2), as well as transmit other data to the local set-top box 202.

In at least one embodiment, the set-top box 202 may be configured to receive over-the-air television programming from a transmitter 408 using a bulk in receiver/tuner. For example, the set-top box 202 may receive local programming over-the-air, and may receive national programming from the transmission network 206A. In at least one embodiment, the set-top box 202 may receive the chat data from the transmitter 408.

As illustrated in FIG. 4, the set-top box 202 may optionally be communicatively coupled to the content provider 208 through a broadband network 410 using a broadband connection 412. The broadband connection 412 may be utilized to provide video programming to the set-top box 202. In at least one embodiment, the broadband network 410 is also utilized to remotely connect the local set-top box 202 and the remote set-top box 210. The broadband network 410 and/or the transmission network 206A may also be utilized to transmit data from the local set-top box 202 to other communication devices, such as computers and mobile telephones.

It is to be appreciated that any combination of the described communication paths may be utilized to transmit video programming between the content provider 208 and the local set-top box 202. For example, the local set-top box 202 may receive video programming through the transmission network 206A, and may request metadata associated with the video programming from the content provider 208 using the broadband network 410. It is also to be appreciated that any combination of the described communication paths maybe utilized to transmit chat data and other content between the local set-top box 202, the remote set-top box 210 and other communication devices. Further, it is to be appreciated that the remote set-top box 210 may receive video programming from the content provider 208 through any of the communication paths described between the local set-top box 202 and the content provider 208. The cable television distribution system 500 may include other components not illustrated herein for the sake of brevity.

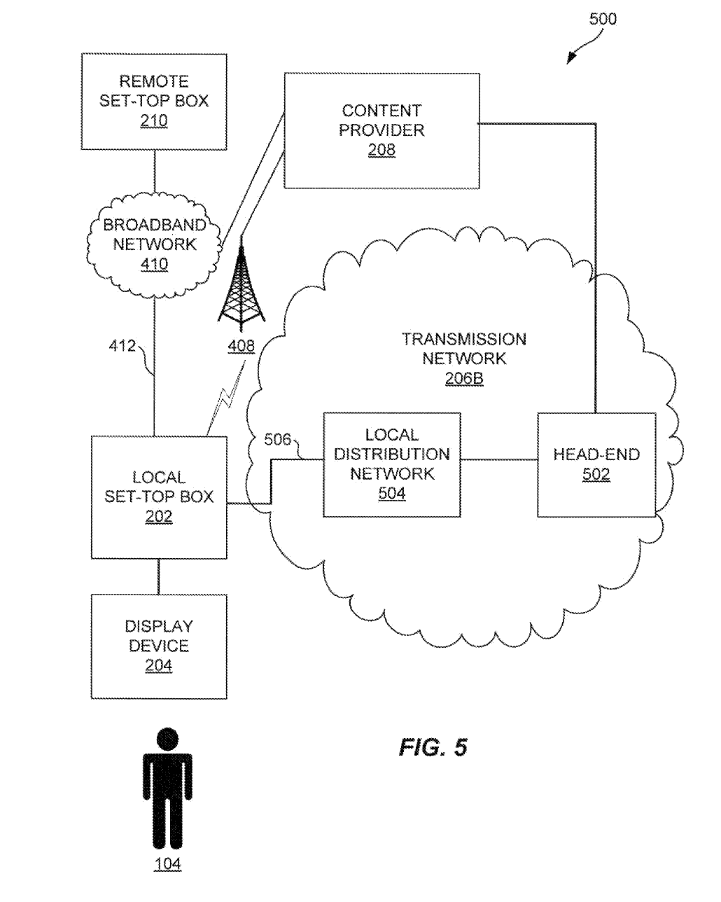

Transmission network 206 (see FIG. 2) may also be embodied in a cable television distribution system. FIG. 5 illustrates an embodiment of a cable television distribution system 500. More particularly, FIG. 5 illustrates details of a transmission network 206B. Cable television distribution system 500 will be discussed in reference to content distribution system 200 illustrated in FIGS. 2-3. Components and communication paths common to the cable television distribution system 500 and the satellite television system 400 are omitted herein for the sake of brevity.

Cable television distribution system 500 comprises a head-end 502 in signal communication with a content provider 208. The content provider 208 provides the head-end 502 with television programs that are transmitted to the display device 204. Television programs may be broadcast by the transmission network 206B, or may be pushed to the local set-top box 202 responsive to a request by the local user 106. Television programs may also be pushed to the local set-top box 202 using a broadband connection 412 through the broadband network 410.

Cable television distribution system 500 further comprises a local distribution network 504 in signal communication with the head-end 502. The local distribution network 504 is operable for receiving content from the head-end 502 and distributing the content to individual display devices 204 and/or the local set-top box 202. The set-top box 202 is in signal communication with the local distribution network 504 using a drop 506 from a feeder line of the local distribution network 504. The local distribution network 504 may provide content as a broadcast to the local set-top box 202, or may provide content to a specific addressable set-top box 202 using the broadband connection 412. In at least one embodiment, the broadband network 410 may be integrated within the transmission network 206B.

In at least one embodiment, chat data communicated between the local set-top box 202 and the remote set-top box 210 may be communicated over the broadband network 410. In other embodiments, chat data may be communicated between the local set-top box 202 and the remote set-top box 210 over the transmission network 206B. For example, chat data between two or more set-top boxes may be provided over a channel of the cable television distribution system. The cable television distribution system 500 may include other components not illustrated herein for the sake of brevity.

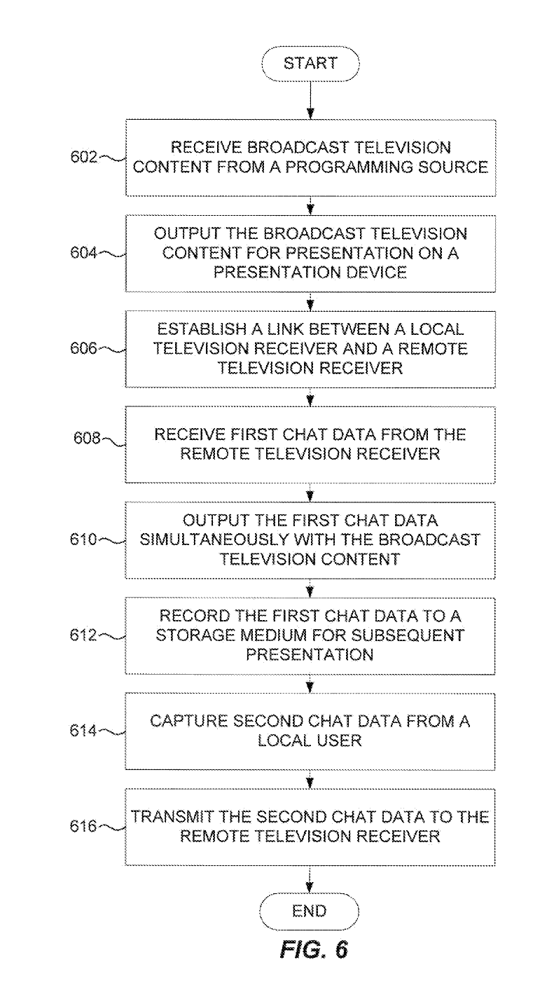

FIG. 6 illustrates an embodiment of a process for providing communication between multiple television viewers. The operation of FIG. 6 is discussed in reference to providing communication between viewers watching broadcast television programming. However, it is to be appreciated that the operation of the process of FIG. 6 may be applied to provide communication between viewers watching other types of video stream content, such as DVD videos, recorded content, video on-demand (VOD) content and the like. The operations of the process of FIG. 6 are not all-inclusive, and may comprise other operations not illustrated for the sake of brevity.

The process includes receiving broadcast television content, on a local television receiver, from a programming source (operation 602). The local television receiver may be internal or external to a presentation device (e.g., a television). For example, broadcast television content may be received by a set-top box for a cable or satellite television distribution system. In other embodiments, the broadcast television content may be received by an integrated tuner of a presentation device.

The process further includes outputting the broadcast television content for presentation on a presentation device (operation 604). If the presentation device and the television receiver are integrated, then operation 604 may include displaying the broadcast television content on a display area of the presentation device. If the local television receiver (e.g., a set-top box) is external to the presentation device, then operation 604 may include generating a video signal outputted to the presentation device over a wired (e.g., coax, component video or HDMI) or wireless connection.

The process further includes establishing a link between a local television receiver and a remote television receiver (operation 606). The link may be established using any type of data communication or video communication transfer protocol. In at least one embodiment, the link between the local television receiver and the remote television receiver is established over an internet protocol (IP) connection on a broadband network. If the local television receiver (e.g., a set-top box) stores information regarding the address of the remote television receiver, then a user interface may be presented to allow a user to initiate a connection and establish the link.

In some embodiments, the link may be established using an intermediate server. For example, the remote television receiver may be identified by a handle or username, and the local television receiver may query the server for the address of the remote television receiver. Responsive to the query, the server may provide the address of the remote television receiver, and the local television receiver may then establish the link.

The process further includes receiving first chat data from the remote television receiver (operation 608). The first chat data may be audio data, video data, text data, image data or any combination thereof. Operation 608 may also include receiving other types of non-broadcast content besides chat data, such as audio or video clips transmitted to the local television receiver by the remote television receiver over the established link.

The process further includes outputting the first chat data simultaneously with the broadcast television content for presentation on the presentation device (operation 610). If the first chat data includes audio data, then the audio chat data may be mixed with audio components of the broadcast television content and presented on an audio output of the presentation device. In some embodiments, audio components of the broadcast television content may be muted so that the audio chat data may be presented without interruption.

If the first data includes video data, then the video data may be presented PIP with the broadcast video content. In at least one embodiment, a user interface is displayed on screen to a user to allow manipulation of the presentation of the broadcast video content and/or the first chat data. For example, a user may want to adjust the volume of the broadcast video content and/or first chat data. A user may also want to temporarily present the first chat video data in a full screen mode without the broadcast video content. In other situations, a user may want to adjust the relatives sizes of the video chat data and the broadcast video content outputted for presentation on the presentation device.

The process further includes recording the first chat data to a storage medium for subsequent presentation (operation 612). In at least one embodiment, if the broadcast video content is also recorded, then the first chat data may be recorded in association with the broadcast video content. Thus, a user may subsequently playback both the broadcast video content and the chat data as they were originally presented together.

The process further includes capturing second chat data from a local user (operation 614). The second chat data may be captured by any type of input device, such as video cameras, microphones, keyboards, mobile telephone, other communication devices and the like. Operation 614 may optionally include recording the second chat data to a storage medium for subsequent presentation on the local presentation device.

In at least one embodiment, the captured second chat data includes audio data, and operation 614 includes performing audio cancellation techniques to filter audio components of the broadcast video content from the captured second chat data. In other words, as sound from the room is captured by a microphone, the sound captured by the microphone includes audio of the broadcast video content emanating from a television. Thus, the local television receiver performs audio cancellation, using the broadcast video content, to filter the audio components of the broadcast television content from the captured chat data. Thus, a remote television receiver receives voice data of a user captured by the local television receiver, but does not receive the audio data of the television program playing on a television coupled to the local television receiver.

The process further includes transmitting the second chat data to a remote television receiver (operation 616). As described above, the local television receiver may transmit the second chat data to the remote television receiver over any type of communication network. Responsive to receiving the second chat data, the remote television receiver outputs the second chat data for presentation on a remote presentation device. In at least one embodiment, the remote television receiver records the second chat data for subsequent presentation on the remote presentation device.

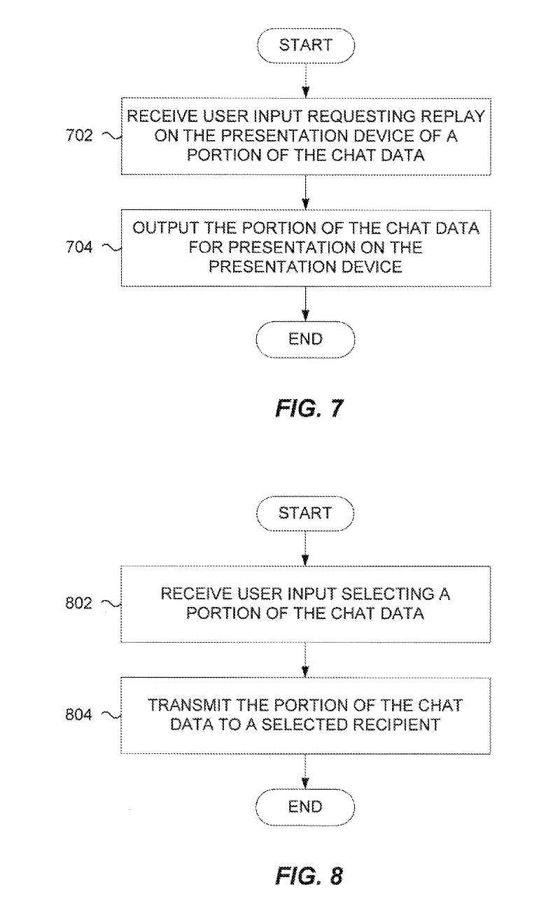

Recorded chat data may be utilized to perform trick play modes (e.g., rewinding or pausing) of the chat data during presentation. For example, if a user is watching a football game while video chatting with a friend, they may want to re-watch their friend's reaction to a touchdown during the game. FIG. 7 illustrates an embodiment of a process for presenting video chat data in trick play modes. The operations of the process of FIG. 7 are not all-inclusive, and may comprise other operations not illustrated for the sake of brevity.

The process includes receiving user input requesting replay on the presentation device of a portion of chat data (operation 702). In other words, a user may rewind the chat data and re-watch a portion of the chat data. Operation 702 may alternatively include receiving user input requesting playback on the presentation device of a portion of any type of non-broadcast content received from a remote-television receiver and presented in association with broadcast video content on a presentation device. A user may initiate playback of the portion of the chat data by pressing a rewind button of a remote control associated with a presentation device and/or set-top box.

The process further includes outputting the portion of the chat data for presentation on the presentation device (operation 704). In at least one embodiment, the chat data is outputted for presentation on the presentation device simultaneously with a substantially real-time presentation of the broadcast television content. In other words, a user may rewind the chat data while continuing to watch the live broadcast video content.

A user may also share chat data with third party recipients. For example, a user may desire to send video of their friend's reaction to a touchdown in a football game to another friend's set-top box, mobile telephone or computer. Likewise, a user may desire to send footage of their own reaction to the touchdown to a third party recipient. FIG. 8 illustrates an embodiment of a process for providing chat data to a third party recipient. The operations of the process of FIG. 8 are not all-inclusive, and may comprise other operations not illustrated for the sake of brevity.

The process includes receiving user input, selecting a portion of the non-broadcast content, for transmission to a selected recipient (operation 802). A user may provide the input using a remote control or other type of input device. In at least one embodiment, a user may utilize the remote control to temporally move through audio or video data and select beginning and ending points of the portion of the chat data. The chat data selected may include audio or video data of the user captured by a local television receiver, or the chat data may include audio or video data received by the local television receiver from a remote television receiver. In other words, users may transmit data of themselves or of other users.

The process further includes transmitting the portion of the chat data content to a selected recipient (operation 804). The chat data may be transmitted to any type of communication device over any type of communication network. In at least one embodiment, the selected recipient is another television user, and the chat data is transmitted to the other user's set-top box through a broadband connection. In some embodiments, the selected recipient is a user of a mobile telephone or a user of a computer. Responsive to receiving the chat data, the third party recipient may initiate playback of the chat data on their presentation device.

Although specific embodiments were described herein, the scope of the invention is not limited to those specific embodiments. The scope of the invention is defined by the following claims and any equivalents therein.

What is claimed is:

1. A method for providing communication between multiple television viewers, the method comprising:
receiving broadcast television content, on a local television receiver, from a programming source;
outputting the broadcast television content for presentation on a presentation device;
establishing a link between the local television receiver and a remote television receiver;
receiving non-broadcast content from the remote television receiver, the non-broadcast content captured by the remote television receiver;
outputting the non-broadcast content simultaneously with the broadcast television content for presentation on the presentation device; and
recording the non-broadcast content to a storage medium for subsequent presentation.

2. The method of claim 1, wherein the non-broadcast content comprises audio chat data captured by the remote television receiver.

3. The method of claim 1, wherein:
the non-broadcast content comprises video chat data captured by the remote television receiver;
the broadcast television content is outputted for presentation in a first region of a display area of the presentation device; and
the non-broadcast content is outputted for presentation in a second region of a display area of the presentation device.

4. The method of claim 3, further comprising:
receiving user input requesting replay on the presentation device of a portion of the non-broadcast content; and
outputting the portion of the non-broadcast content for presentation on the presentation device while simultaneously outputting the broadcast television content for substantially real-time presentation on the presentation device.

5. The method of claim 1, further comprising:
capturing video data of a viewer of the presentation device;
transmitting the video data to the remote television receiver; and
recording the video data to the storage medium for subsequent presentation on the presentation device.

6. The method of claim 5, further comprising:
receiving user input requesting replay of a portion of the video data; and
outputting the portion of the video data for presentation on the presentation device while simultaneously outputting the broadcast television content for substantially real-time presentation on the presentation device.

7. A method for providing video chat services between multiple television viewers, the method comprising:
receiving broadcast television content, on a local television receiver, from a programming source;
outputting the broadcast television content for presentation in a first region of a display area of a presentation device;
establishing a link between the local television receiver and a remote television receiver;
receiving video chat data from the remote television receiver, the video chat data captured by the remote television receiver;
outputting the video chat data simultaneously with the broadcast television content in a second region of the display area;
receiving user input selecting a portion of the video chat data; and
transmitting the portion of the video chat data to a selected recipient.

8. The method of claim 7, wherein transmitting the portion of the video chat data further comprises transmitting the video chat data to a second remote television receiver.

9. The method of claim 7, further comprising recording the video chat data to a storage medium for subsequent presentation.

10. The method of claim 9, further comprising:
receiving user input requesting replay of a portion of the video chat data; and
outputting the portion of the video chat data for presentation on the presentation device while simultaneously outputting the broadcast television content for substantially real-time presentation on the presentation device.

11. The method of claim 7, further comprising:
capturing second video data of a viewer of the presentation device;
receiving user input selecting a portion of the second video data; and
transmitting the portion of the video chat data to the selected recipient.

12. A digital video recorder comprising:
a receiver that receives broadcast television content from a programming source;
a processor communicatively coupled to the receiver that:
outputs the broadcast television content for presentation on a presentation device;
establishes a link to a remote television receiver;
receives non-broadcast content from the remote television receiver, the non-broadcast content captured by the remote television receiver;
outputs the non-broadcast content simultaneously with the broadcast television content for presentation on the presentation device; and
a storage medium communicatively coupled to the processor that stores the non-broadcast content to a storage medium for subsequent presentation.

13. The digital video recorder of claim 12, wherein the non-broadcast content comprises audio chat data captured by the remote television receiver.

14. The digital video recorder of claim 12, wherein the non-broadcast content comprises video chat data captured by the remote television receiver, and wherein the processor:
outputs the broadcast television content for presentation in a first region of a display area of the presentation device; and
outputs the non-broadcast content for presentation in a second region of a display area of the presentation device.

15. The digital video recorder of claim 12, further comprising:
an input module that receives user input requesting replay on the presentation device of a portion of the non-broadcast content; and
wherein the processor outputs the portion of the non-broadcast content for presentation on the presentation device while simultaneously outputting the broadcast television content for substantially real-time presentation on the presentation device.

16. The digital video recorder of claim 12, further comprising:
a microphone communicatively coupled to the processor that captures audio data of a viewer of the presentation device;
wherein the processor transmits the audio data to the remote television receiver; and
wherein the storage medium records the audio data for subsequent presentation on the presentation device.

17. The digital video recorder of claim 12, further comprising:
a video camera communicatively coupled to the processor that captures video data of a viewer of the presentation device;
wherein the processor transmits the video data to the remote television receiver; and
wherein the storage medium records the video data for subsequent presentation on the presentation device.

18. The digital video recorder of claim 17, further comprising:
an input module that receives user input requesting replay on the presentation device of a portion of the video data; and
wherein the processor outputs the portion of the video data for presentation on the presentation device while simultaneously outputting the broadcast television content for substantially real-time presentation on the presentation device.

19. A digital video recorder including:
a receiver that receives broadcast television content from a programming source;
a processor communicatively coupled to the receiver that:
establishes a link to a remote television receiver;
receives video chat data from the remote television receiver, the video chat data captured by the remote television receiver;
outputs the broadcast television content for presentation in a first region of a display area of a presentation device; and
outputs the video chat data simultaneously with the broadcast television content in a second region of the display area; and
an input module communicatively coupled to the processor that receives user input selecting a portion of the video chat data;
wherein the processor transmits the portion of the video chat data to a selected recipient

20. The digital video recorder of claim 19, wherein the selected recipient comprises a second remote television receiver.

21. The digital video recorder of claim 19, wherein:
the processor records the video chat data to a storage medium for subsequent presentation;
the input module receives user input requesting replay of a portion of the video chat data; and
the processor outputs the portion of the video chat data for presentation on the presentation, device while simultaneously outputting the broadcast television content for substantially real-time presentation on the presentation device.

22. The digital video recorder of claim 19, further comprising;
a video camera that captures second video data of a viewer of the presentation device;
wherein the input module receives user input selecting a portion of the second video data; and
wherein the processor transmits the portion of the second video chat data to the selected recipient.
